(19) United States
(12) Patent Application Publication
(10) Pub. No.: US 2011/0141463 A1
(43) Pub. Date: Jun. 16, 2011

(54) DEFECT INSPECTION METHOD, AND DEFECT INSPECTION DEVICE

(76) Inventors: Shuichi Chikamatsu, Konosu (JP); Minoru Noguchi, Joso (JP); Masayuki Ochi, Kamisato (JP); Kenji Aiko, Hitachinaka (JP)

(21) Appl. No.: 13/059,593

(22) PCT Filed: Jul. 15, 2009
(86) PCT No.: PCT/JP2009/063140

§ 371 Date: Feb. 17, 2011

(30) Foreign Application Priority Data
Aug. 29, 2008 (JP) 2008220692

(51) Int. Cl. G01N 21/956

(52) U.S. Cl. 356/237.5

(57) ABSTRACT

Provided are a defect inspection device and a defect inspecting method, which enlarge the uptake range of a light scattered from a fine defect thereby to heighten signal intensity. The defect inspection device is provided with: a stage unit (300) capable of mounting an inspection object substrate (1) thereon to move same relative to an optical device; an illuminating optical device (100) for illuminating an inspection zone (4) on the inspection object substrate (1); a detecting optical device (200) for detecting a light from the inspection zone (4) of the inspection object substrate (1); an image sensor (205) for converting the image focused by the detecting optical device (200) into signals; a signal processing unit (402) for processing the signals from the image sensor (205) thereby to detect a defect; and a plane reflecting mirror (501) arranged between detecting optical device (200) and the inspection object substrate (1) and transmitting the light from the inspection object substrate (1) to the detecting optical device (200).

### TECHNICAL FIELD

The present invention relates to a defect inspection method and a defect inspection device and particularly to a technology suited for inspecting the situation of generation of defects such as foreign matters in a fabrication process in which defects such as foreign matters generated during the process are detected and analyzed to take measures during those processes in which object devices are produced by forming a pattern on a substrate, including a semiconductor fabrication process, a liquid crystal display element fabrication process, and a printed circuit board fabrication process.

### BACKGROUND ART

In a semiconductor fabrication process, any foreign matters on a substrate to be inspected (wafer) can lead to insulation failures and short-circuits. Furthermore, as the semiconductor devices are becoming miniaturized, the presence of minute foreign matters can result in insulation failures in capacitors and breakage of gate oxide films and the like. These foreign matters can enter in various states such as ones generated from moving parts of a transfer equipment, ones generated from human bodies, ones produced by reactions with process gasses in the processing equipment, and ones pre-mixed in chemicals and raw materials.

Similarly in a process of fabricating liquid crystal display elements, adhesion of foreign matters to or formation of some defects on patterns formed on a liquid crystal display element substrate make useless as the display element. The same is true of a printed circuit board fabrication process and the adhesion of foreign matters can cause short-circuits and poor connections in patterns.

As one of conventional technologies of this kind for detecting foreign matters on substrates to be inspected, as described in Patent Literature 1, a technology is disclosed which eliminates false reports caused by patterns to detect foreign matters and defects with high sensitivity and high reliability by radiating a laser onto the substrate to be inspected, detecting scattered light from the foreign matters generated when foreign matters adhere on the substrate to be inspected, and comparing the inspection result with that of a substrate to be inspected of the same kind inspected immediately before. There is another technology which involves, as disclosed in Patent Literature 2, radiating a laser onto a substrate to be inspected, detecting scattered light from foreign matters when foreign matters adhere to the substrate to be inspected, and analyzing the detected foreign matters by analysis techniques such as a laser photoluminescence analysis or a two-dimensional X ray analysis (XMR).

As another technique for inspecting the aforementioned foreign matters, a method is disclosed in which coherent light is radiated onto the wafer, light emitted from repeating patterns on the wafer is removed by a spatial filter, and foreign matters and defects that do not have repetitiveness are emphasized. Further, in Patent Literature 3 a foreign matter inspection device is known which prevents 0th-order diffracted light coming from the group of main straight lines of the circuit pattern from entering an aperture of a detection lens by radiating onto a circuit pattern formed on the wafer at 45 degrees to a group of main straight lines. The Patent Literature 3 also describes a method of shading other straight line groups than the main straight line group by a spatial filter. As for conventional techniques concerning an apparatus for inspecting defects such as foreign matters and its inspection method, Patent Literature 4 describes changing a detection pixel size by switching between detection optic systems. Patent Literature 5 and Patent Literature 6 are disclosed as methods for measuring the size of foreign matters. In Patent Literature 7 a method of detecting defects on a thin film is used, which involves focusing a laser light to form a beam spot elongated in a direction perpendicular to a direction in which a stage is moved and detecting defects from a direction at right angles to the illumination direction.

### [Citation List]

### [Patent Literature]

### Patent Literature 1: JP-A-62-89336

### Patent Literature 2: JP-A-63-135848

### Patent Literature 3: JP-A-1-117024

### Patent Literature 4: JP-A-2000-105203

### Patent Literature 5: JP-A-2001-60607

### Patent Literature 6: JP-A-2001-264264

### Patent Literature 7: JP-A-2004-177284

### SUMMARY OF INVENTION

### [Technical Problem]

In order to detect defects which become smaller, signal intensities of defects may be enhanced by enlarging the range in which a detection optic system picks up light scattered by the defects. To this end it is effective to increase a numerical aperture (NA) of the detection optic system disposed above. If a lens diameter is not increased, a distance between a front end of a lens and the substrate to be inspected needs to be short and it is impossible to increase the angle of an inclined illumination from outside an optical axis of the detection optic system; as a result the power radiated to the defects decreases, which renders the enhancing of the detection signal impossible. On the other hand, while increasing the lens diameter can elongate the distance between the front end of the lens and the substrate to be inspected, the increased NA ratio, however, also increases a ratio of lens diameter to focal length, resulting in a significant increase in the size of the optic system, giving rise to a new problem that manufacturing of the lens and its mounting on the inspection device become difficult.

To pick up scattered light from defects which reflects to the outside of the pickup range of a vertical optical axis of the detection optic system, there are methods of adding to the detection optic system a mechanism to incline the optical axis of the detection optic system for inclined detection from oblique angles or additionally providing an oblique detection system. However, since the optical axis of the overhead detection lens or the additional inclined detection system comes into contact with the surface of the substrate to be detected when its angle of elevation is smaller than a certain angle, detection cannot be made at low elevation angles. To avoid such a contact at lower elevation angles, the NA of the detection optic system may be reduced to make the cylinder diameter of the detection system lens small. Although this avoids the contact to some extent, the amount of light that can enter and a signal strength is reduced. Furthermore, these method, which require an inclination mechanisms for the overhead optic system or a set of an image sensor and a lens for oblique detection, a spatial filter unit and a detection area observatory optic system, give rise to new problems, such as an enlarged size of optic system, an increased cost of parts, and an increased number of adjustment steps.

One of objects of this invention is to provide a defect inspection device and a defect inspection method which expand the range for picking up light scattered from minute defects and thereby enhance the strength of detection signal.

### [Solution to Problem]

One of features of this invention is a method which involves illumination a substrate to be inspected, focusing light picked up from an illuminated area, converting the formed image into a signal strength, and inspecting the substrate to be inspected with light and which is characterized in that the light is transmitted through an optical element between the substrate to be inspected and the formed image.

Another feature of this invention is an inspection device characterized in that it comprises a stage on which a substrate to be inspected is mounted and moves relative to an optic system; an illumination system to illuminate an inspection area on the substrate to be inspected; a detection optic system to make light from the substrate to be inspected enter to focus the light from the inspection area of the substrate to be inspected onto an image sensor; the image sensor to convert the image formed by the detection optic system into a signal; a signal processing system to detect defects from the signal from the image sensor; and an optical element disposed between the detection optic system and the substrate to be inspected. The inspection device is also characterized in that it transmits light from the substrate to be inspected through the optical element.

Still another feature of this invention is a planar reflection mirror which is disposed between the detection lens and the substrate to be inspected to reflect the light obtained from the illuminated area and to focus it on the image sensor, thus realizing an oblique inspection.

### [Advantageous Effects of Invention]

With this invention, the oblique inspection with a high NA and at a low angle of elevation can easily be realized, raising the expectation that defect types that can be detected will expand and the number of detectable defects will also increase.

### BRIEF DESCRIPTION OF DRAWINGS

FIG. 1 is a diagram showing an example structure of a defect inspection device according to this invention.

FIG. 2 is a diagram showing a substrate to be inspected having an array of LSI's disposed as samples to be inspected.

FIG. 3 is an explanatory diagram of three illumination inspection lights produced by an illumination optic system in the defect inspection device according to this invention.

FIG. 4 is a diagram showing an optic system including an illumination lens of the illumination optic system in the defect inspection device according to this invention.

FIG. 5 is a diagram showing a function of the illumination lens of the illumination optic system in the defect inspection device according to this invention.

FIG. 6 is an explanatory diagram of a first embodiment according to this invention.

FIG. 7 is a schematic diagram of a second embodiment according to this invention.

FIG. 8 is a schematic diagram of a third embodiment according to this invention.

FIG. 9 is a schematic diagram of a fourth embodiment according to this invention.

FIG. 10 is a schematic diagram of a fifth embodiment according to this invention.

FIG. 11 is a schematic diagram of a sixth embodiment according to this invention.

FIG. 12 is a schematic diagram of a seventh embodiment according to this invention.

FIG. 13 is a schematic diagram of an eighth embodiment according to this invention.

FIG. 14 is a schematic diagram of a ninth embodiment according to this invention.

FIG. 15 is a schematic diagram of a tenth embodiment according to this invention.

FIG. 16 is a model diagram showing a pattern, a defect, and directions of scattered light.

FIG. 17 is a diagram illustrating a relationship between a bearing in which to detect scattered light and an illumination bearing in a detection optic system.

FIG. 18 is a schematic diagram of a twelfth embodiment of an oblique inspection according to this invention.

FIG. 19 is an explanatory diagram showing an appropriate range of the illumination bearing y in the twelfth embodiment.

FIG. 20 is a schematic diagram of an eleventh embodiment of the oblique inspection according to this invention.

FIG. 21 is a schematic diagram of a thirteenth embodiment of the oblique inspection according to this invention.

FIG. 22 is a schematic diagram of a fourteenth embodiment of the oblique inspection according to this invention.

### DESCRIPTION OF EMBODIMENT

Now, embodiments of this invention will be described by referring to the drawings. In the following drawings identical functional parts are given the same reference numerals.

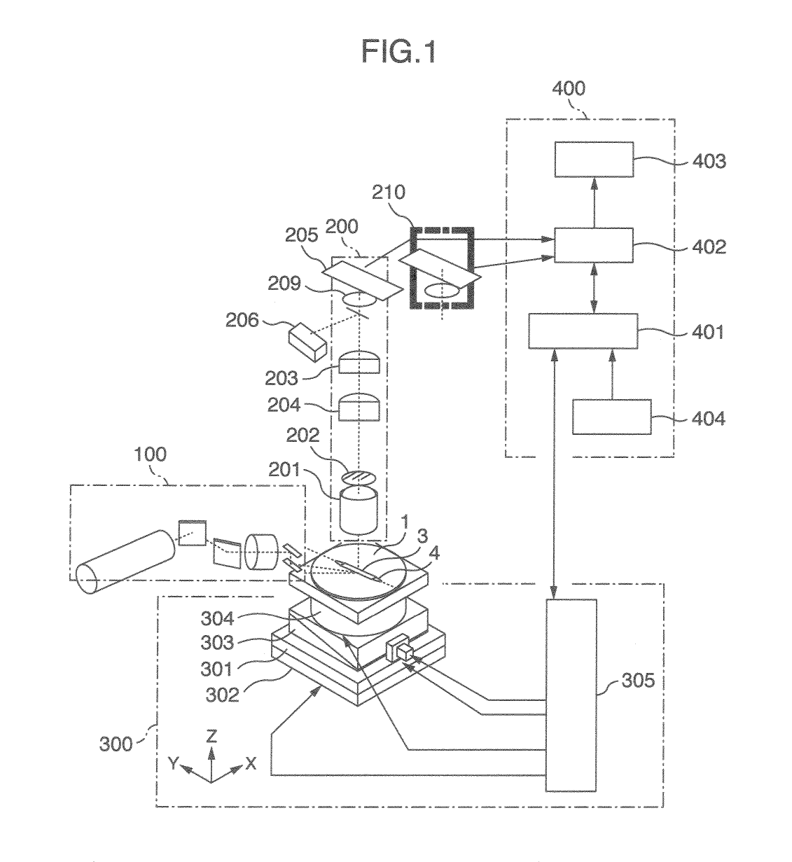

An embodiment of a defect inspection device according to this invention will be explained by referring to FIG. 1.

The defect inspection device shown has a stage portion 300 on which to mount a substrate to be inspected 1, an illumination optic system 100 to throw a beam spot 3, which is a slit-like illuminated area, onto the substrate to be inspected 1, a detection optic system 200 to detect scattered light from a detection area 4 of an image sensor, and a control system 400 to execute various calculation processing.

The stage portion 300 comprises an X stage 301 and a Y stage 302 movable relative to the optic system to scan an inspection area in the substrate to be inspected 1 in XY directions, a Z stage 303 capable which enables focusing on the surface of the substrate to be inspected 1, a theta (θ) stage 304, and a stage controller 305.

The illumination optic system 100 comprises a laser source, a beam expander, a group of optical filters, mirrors, an optical branching element (or a mirror) capable of changing over a glass plate, and a beam spot focusing portion. The laser source of the illumination optic system 100 may preferably use a third harmonic THG of a high-power YAG laser with a wavelength of 355 nm, but not necessarily with 355 nm. In other words, the laser source may be other light source, such as an Ar laser, a nitrogen laser, a He—Cd laser, and an excimer laser.

The detection optic system 200 is used for an overhead inspection and comprises a detection lens 201, a spatial filter 202, an image formation lens 203, a zoom lens group 204, a one-dimensional image sensor (image sensor) 205, an observatory optic system (camera) 206 capable of observing the detection area of the image sensor, a polarizing beam splitter 209, and a branch detection optic system 210 to perform a two-sensor simultaneous inspection. The one-dimensional image sensor 205 may be a CCD or a TDI (time delay integration) sensor. When a CCD is used, since the pixel size in general is about 10 μm, it can be considered a line detection, which is free from degradations in sensitivity that would be caused by picking up an image not focused in the scan direction. In the case of a TDI sensor, on the other hand, since it integrates an image composed of a certain number of pixels in the scan direction, it is desired that some measures be taken, such as reducing an illumination width or inclining the TDI sensor, to reduce the amount of unfocused image to be picked up. A coordinate system is shown at the lower left in FIG. 1. XY axes are taken on a horizontal plane with a Z axis extending upward in a vertical direction. An optical axis of the detection optic system 200 is placed parallel to the Z axis.

The control system 400 comprises a signal processing portion 402, a control CPU portion 401, a display portion 403, and an input portion 404. The signal processing portion 402 comprises an A/D converter portion, a data memory capable of a delay, a differential processing circuit to obtain signal differences between chips, a memory temporarily storing an inter-chip difference signal, a threshold value calculation processing portion which specifies pattern threshold values and a comparison circuit. The control CPU portion 401 stores a result of detection of a defect such as foreign matters and controls an output means for outputting the defect detection result, the driving of motors and the like, the coordinates, and the sensors.

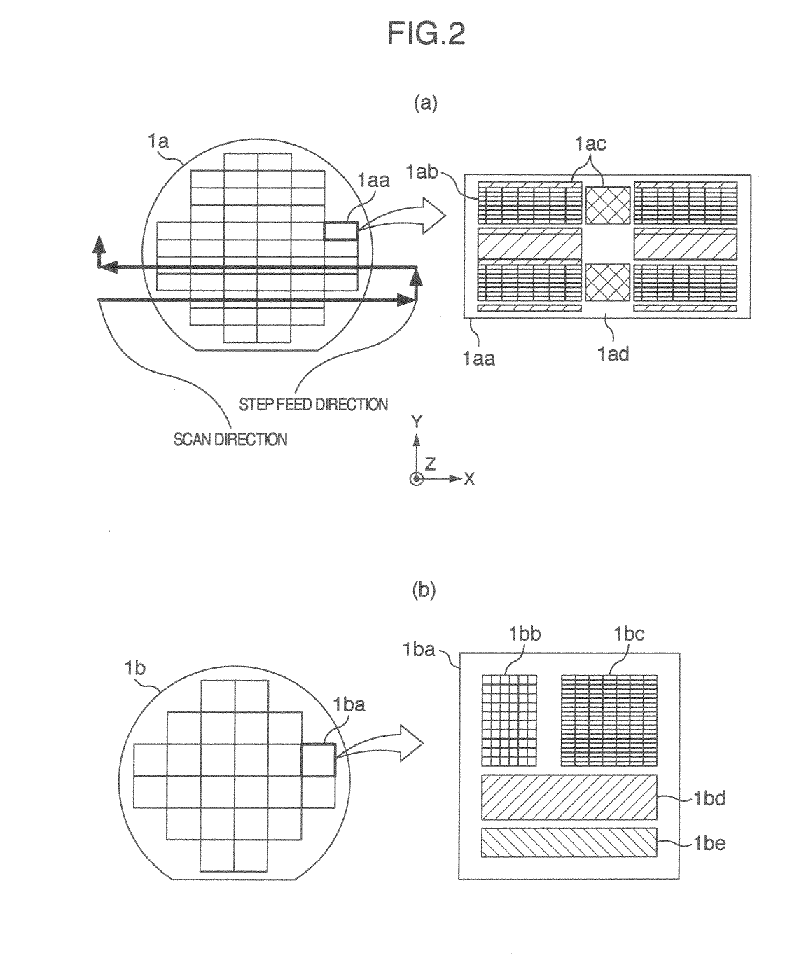

Referring to FIG. 2, a sample to be inspected by the defect inspection device of this invention will be explained. A substrate to be inspected 1a shown in FIG. 2(a) has memory LSI chips 1aa two-dimensionally arrayed at predetermined intervals. Each of the memory LSI chip 1aa mainly has a memory cell area 1ab, a peripheral circuit area 1ac comprised of a decoder, a control circuit, and the like, and another area 1ad. The memory cell area 1ab has a memory cell pattern regularly arrayed two-dimensionally, i.e., a repetitive memory cell pattern. The peripheral circuit area 1ac has a circuit pattern not regularly arrayed two-dimensionally, i.e., a non-repetitive pattern.

A substrate to be inspected 1b shown in FIG. 2(b) has LSI chips 1ba such as microcomputers two-dimensionally arrayed at predetermined intervals. Each of the LSI chips 1ba such as microcomputers mainly has a register group area 1bb, a memory portion area 1bc, a CPU core portion area 1bd, and an input/output portion area 1be. FIG. 2(b) conceptually shows an array of the memory portion area 1bc, the CPU core portion area 1bd, and the input/output portion area 1be. The register group area 1bb and the memory portion area 1bc have patterns regularly arrayed two-dimensionally, i.e., a repetitive pattern. The CPU core portion area 1bd and the input/output portion area 1be have a non-repetitive pattern. As described above, the objects to be inspected by the defect inspection device of this invention generally has chips regularly arranged as with the substrate to be inspected (wafer) 1 shown in FIG. 2. In each chip, a minimum line width differs from one area to another and repetitive and non-repetitive patterns are included in one chip, making the chip configuration varied widely.

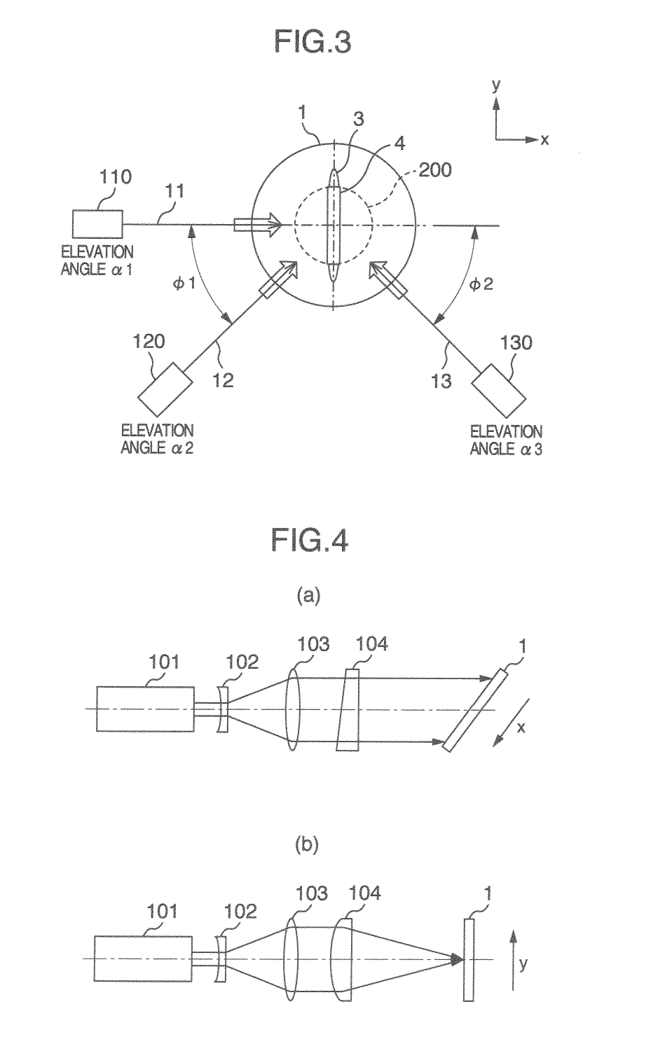

Referring to FIG. 3, three beam spot formation portions of the illumination optic system 100 are explained: a first beam spot formation portion 110, a second beam spot formation portion 120, and a third beam spot formation portion 130. FIG. 3 is a view of the substrate to be inspected 1 seen from above.

An inspection illumination light in an X-axis direction 11 is thrown through the first beam spot formation portion 110, an inspection illumination light at an angle of −45 degrees to the Y axis beam 12 is thrown through the second beam spot formation portion 120, and an inspection illumination light at an angle of 45 degrees to the Y axis 13 is thrown through the third beam spot formation portion 130.

These inspection illumination lights 11, 12, and 13 are radiated onto the surface of the substrate to be inspected 1 at a predetermined elevation angle α. By minimizing the elevation angle α of the inspection illumination lights 12 and 13 in particular, the amount of detection of scattered light from a lower surface of a transparent thin film can be reduced. By these inspection illumination lights 11, 12, and 13, an elongated beam spot 3 is formed on the substrate to be inspected 1. The beam spot 3 is elongated in the Y-axis direction. The length of the beam spot 3 in Y-axis direction is greater than an image sensor detection area 4 of the one-dimensional image sensor 205 in the detection optic system 200.

A reason why the three beam spot formation portions 110, 120, and 130 are provided in the illumination optic system 100 is explained below. Let angles that the images formed by projecting the inspection illumination lights 12 and 13 onto the XY plane make with the X axis be φ1 and φ2, respectively. In this example, φ1=φ2=45 degrees. Then, since the main direction of the non-repetitive pattern on the substrate to be inspected 1 is a linear pattern extending in the X- or Y-axis direction, the illumination lights are thrown at 45 degrees to the pattern. So, a diffracted light enters an entrance pupil of the detection lens 201 as a component in the X- or Y-axis direction. However, when the beam elevation angle α is low, a specularly reflected light also has a low elevation angle α. So, the diffracted light as the X- or Y-axis component similarly moves away from the area of entrance pupil of the detection lens 201, thus preventing the diffracted light from entering the detection optic system 200. This is detailed in Japanese Patent No. 3566589 (particularly in paragraphs [0033] to [0036]), for example, and further explanation is omitted here.

The non-repetitive pattern on the substrate to be inspected 1 mainly consists of linear patterns formed in parallel and in orthogonal. These linear patterns extend in the X- or Y-axis direction. Since the pattern on the substrate to be inspected 1 bulge to form, recessed portions are formed between the adjoining linear patterns. Therefore, the inspection illumination lights 12 and 13 radiated at an inclination of 45 degrees to the X or Y axis are blocked by a bulging circuit pattern and cannot illuminate the recessed portions between the linear patterns.

Therefore, the first beam spot formation portion 110 that throws the inspection illumination light 11 in the X-axis direction is provided. Then, the recessed portions between the linear patterns can be illuminated with the inspection illumination light 11, allowing for the detection of defects such as foreign matters. Depending on the direction of linear patterns, the sample may be turned 90 degrees for inspection or the inspection illumination light 11 may be radiated along the Y axis.

Moreover, when the recessed portions between the linear patterns in the X-axis direction are illuminated as by the inspection illumination light 11, a zero-th order diffracted light needs to be blocked so as the image sensor would not detect the zero-th order diffracted light. To this end, the spatial filter 202 is provided.

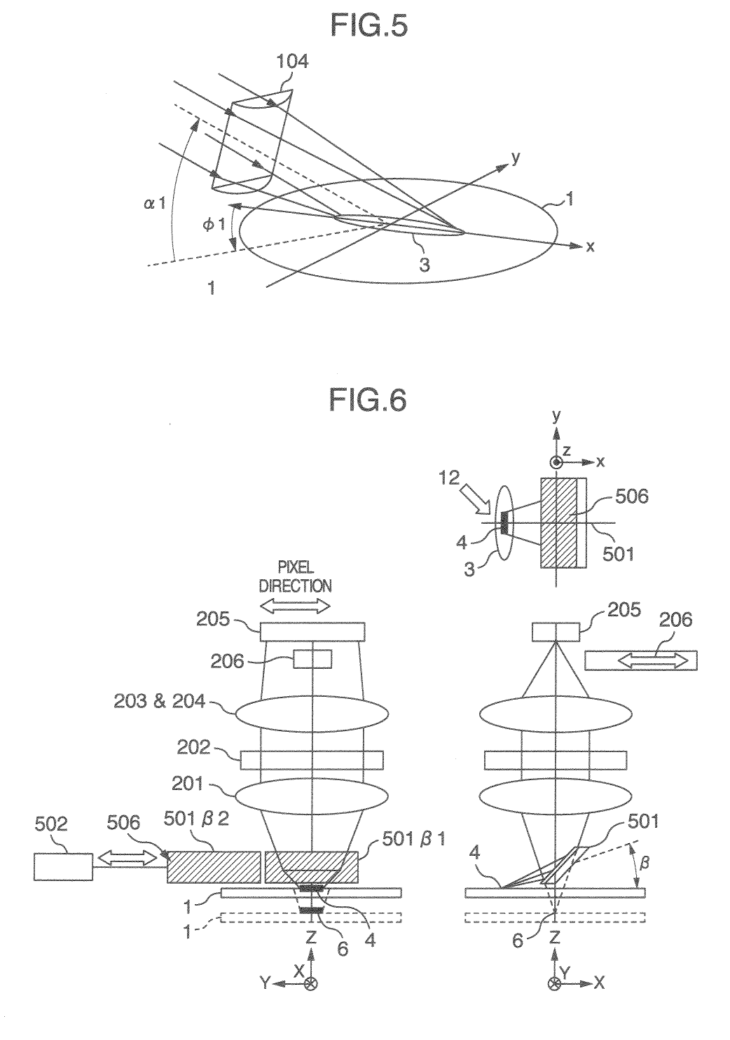

Referring to FIG. 4 and FIG. 5, how the elongated beam spot 3 is formed will be explained. In FIG. 4 and FIG. 5, of the illumination optic system 100, only a laser source 101, a concave lens 102, a convex lens 103, and an illumination lens 104 are shown while other elements are omitted.

The illumination lens 104 is a cylindrical lens with a circular conical surface. It linearly changes its focal length along its longitudinal direction (vertical direction in FIG. 4(a)) as shown in FIG. 4(a) and, as shown in FIG. 4(b), has a cross section of a plano-convex lens. As shown in FIG. 5, the illumination lens 104 also can focus in the Y direction an illumination light thrown onto the substrate to be inspected 1 at an inclination and produce a slitlike beam spot 3 collimated in the X direction. Let an angle that the illumination light forms with the surface of the substrate to be inspected 1 (angle of elevation) be α1 and an angle that the image of the inspection illumination light 11 thrown onto the substrate to be inspected 1 forms with the X axis be φ1.

With such an illumination lens 104, it is possible to realize an illumination that has a collimated light in the X direction and has nearly an angle of φ1=45 degrees. The method of manufacturing the illumination lens 104 with a circular conical surface and the like is described in detail, for example, in Japanese Patent No. 3566589 (particularly in paragraphs [0027] to [0028]) and it can be manufactured with a publically known method.

### First Embodiment

Referring to FIG. 6, a first embodiment of the oblique inspection according to this invention will be described. An object of this embodiment is to realize a system characterized with an oblique inspection using an overhead detection optic system in order to detect defects on a substrate to be inspected 1 with light.

A planar reflection mirror 501 is disposed between a detection lens 201 and a substrate to be inspected 1. The planar reflection mirror 501 reflects oblique scattered light obtained from an image sensor detection area 4 on the substrate to be inspected 1. The scattered light reflected by the planar reflection mirror 501 is imaged onto an image sensor 205 by the detection optic system. To this end the reflecting surface of the planar reflection mirror is arranged parallel to a pixel direction (longitudinal direction) of the image sensor and inclined to an optical axis of the detection lens. The detection area 4 of the image sensor does not need to match with the optical axis of the detection lens but can be shifted in a direction perpendicular to the pixel direction of the image sensor 205, i.e., in the X-axis direction, to perform an oblique inspection.

In order to eliminate a “kick-out” of a light path, the planar reflection mirror 501 needs to have a Y-direction size sufficiently larger than a diameter of the light path corresponding to the NA of the detection lens 201. When a detection elevation angle β of the oblique detection is determined, it is desired that the length of the reflecting surface be set to a maximum permissible dimension that prevents the planar reflection mirror from coming into contact with the detection lens 201 or the substrate to be inspected 1 when the overhead detection and the oblique detection, which leaves a gap of, for example, 0.2 mm to 1 mm. In that case, setting the upper and lower faces of the planar reflection mirror 501 horizontal can make the reflecting area of the mirror largest. It is also preferred that the planar reflection mirror 501 be set at a position in the X direction that makes the NA of the incoming light maximum.

When the light from the image sensor detection area 4 is imaged onto the image sensor 205, the focus of the detection lens 201 needs to be placed on the image sensor detection area 4. To this end, it is desired in this embodiment that the Z stage 303 be raised from a detection area 6 for the overhead inspection to the height of the focus of the detection lens 201 so that the focus matches onto the image sensor detection area 4 for the oblique detection by an auto-focusing mechanism. If the optical axis of the auto-focusing mechanism passes through the detection lens, no modification needs to be made of the auto-focusing mechanism during the oblique detection. But if an off-axis type auto-focusing mechanism whose optical axis does not pass through the detection lens is chosen, the auto-focusing mechanism needs to be moved by +ΔZ in the Z-axis direction in accordance with the amount of movement of the stage Z of ΔZ. It is also possible to determine a distribution of surface height by storing XYZ coordinates of the substrate to be inspected 1 in advance and to reproduce the surface height distribution during the inspection. Further, when the light from the image sensor detection area 4 is imaged onto the image sensor 205, it is desired that the distribution center and angle of beam spot 3 be made to match those of the image sensor detection area 4.

The planar reflection mirror 501 is so constructed that it can be inserted into or retracted from the light path by a switching mechanism 502. In this embodiment, when during the overhead inspection the light from the image sensor detection area 6 is imaged onto the image sensor 205 by the detection optic system 200 for inspection (overhead inspection), the planar reflection mirror 501 is retracted from the light path. When the image sensor detection area 4 is imaged onto the image sensor 205 by the detection optic system 200 for inspection (oblique inspection), the planar reflection mirror 501 is returned to the position shown in FIG. 6.

With this arrangement, it is possible to construct a detection optic system for the oblique inspection in which the planar reflection mirror 501 is inserted in the light path and a detection optic system for the overhead inspection in which the planar reflection mirror 501 is taken out of the light path, thus allowing for selection between the oblique inspection and the overhead inspection. In two inspections results of the overhead inspection and the oblique inspection can be obtained and, using signal strengths and areas of defect obtained from the overhead inspection and the oblique detection performed on a defect at the same coordinates, the calculation of the defect size and the categorization of the defect can be made with higher precision.

It is desired to adopt a flexible structure so that the angle of elevation of light entering the planar reflection mirror 501 can be changed according to the distribution of scattered light from a defect to be detected. The extraction and categorization of defects can be done with improved precision by performing the oblique inspection at different detection elevation angles, storing the signal strengths and coordinates in memories of respective signal processing systems, and comparing the signal strengths obtained at different detection elevation angles. The construction shown in FIG. 6 changes the elevation angle of scattered light to be detected, by the switching mechanism 502 moving the two planar reflection mirrors 501, which cause the scattered light with an elevation angle of β1 or β2 to enter the detection lens 201, in a direction of blank arrow. By changing the angle of the reflecting surface of the planar reflection mirrors 501, the oblique inspection can be made of the scattered lights of different detection elevation angles. The detection elevation angle β is desirably arranged so that the remaining NA except the NA of the overhead detection lens 201 can be divided by β1 and β2. This allows the scattered light from the defect to be detected in the X-axis direction with NA of 0.9 or higher, which results in an enhanced signal strength of a defect whose scattered light distribution has a directivity, and improving a sensitivity. As described above, this embodiment can expand the range in which scattered lights from minute defects are picked up and thereby enhance the signal strength. This effect can also be produced similarly in the following embodiments.

The magnification of an image being inspected can be changed during the oblique inspection on the image sensor detection area 4 by changing the position of the zoom lens group 204 in the same way that it is changed when performing the overhead inspection on the image sensor detection area 6 by changing the position of the zoom lens group 204. Because the detected pixel size of the substrate to be inspected 1 can be changed by this, a reduced pixel size can improve the S/N (=a ratio of a defect signal strength to a pattern signal strength) and an enlarged pixel size can reduce throughput.

Like the Fourier-transformed image of the image sensor detection area 6 can be filtered by the spatial filter 202 during the overhead inspection, the Fourier-transformed image of the image sensor detection area 4 also can be filtered by the spatial filter 202 since the Fourier image in the pixel direction depends on the pattern pitch during the oblique inspection.

Like the image sensor detection area 6 can be observed by the observatory optic system 206 during the overhead inspection, the image sensor detection area 4 can be observed by the observatory optic system 206 of the detection optic system. This obviates the need to add an observation function for oblique inspection.

### Second Embodiment

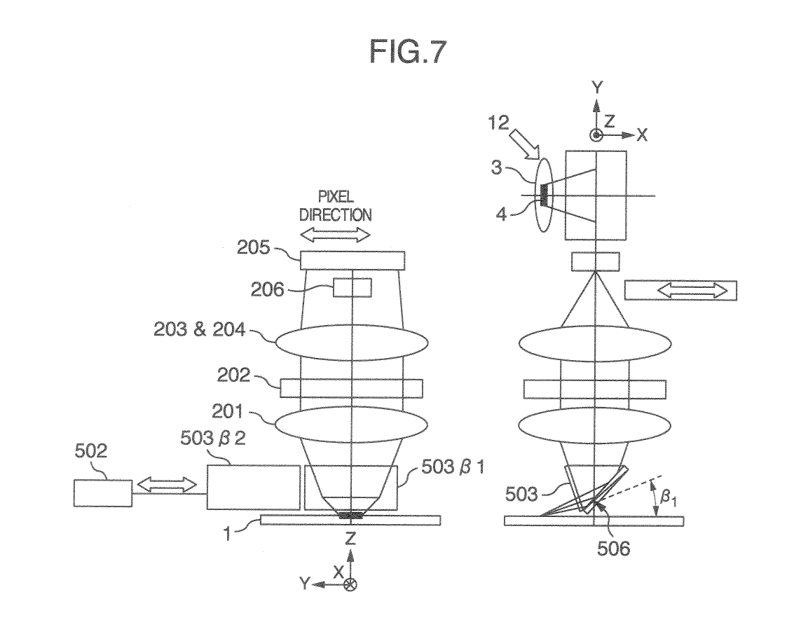

Referring to FIG. 7, a second embodiment of the oblique inspection according to this invention will be explained. The object of this embodiment is to realize a method capable of the overhead inspection and the oblique inspection without changing the stage height as is done in the first embodiment, by setting the stage height of the detection optic system during the overhead inspection and the stage height during the oblique inspection equal or nearly equal and making the focus height of the auto-focus system follow within a pull-in range. For this purpose, it is preferred that an optical path length correction element 503 be disposed between the planar reflection mirror (in this example, a reflecting surface 506 of the optical path length correction element 503) and the detection optic system 200 to extend the optical path length from the inspection area in the substrate to be inspected 1 to the detection lens 201. The optical path length can be extended by as much as (1-1/refractive index) times the optical path length passing through the optical path length correction element 503. This method is characterized in that, by forming the optical path length correction element 503 as a prism, this method can use a larger correction quantity than a third embodiment described later. One surface (reflecting surface 506) of the optical path length correction element 503 is formed with a dielectric multilayer coating that reflects an incident light with a high reflectivity.

FIG. 7 shows a construction in which two optical path length correction elements 503, which are designed to direct scattered lights with two elevation angles of β1 and β2 to the detection lens 201, with their reflecting surfaces 506 set at different angles can be moved in a direction of the blank arrow by the switching mechanism 502 to switch between the two elevation angles of the scattered light to be detected. Also, while in the first embodiment described above the detection optic system is focused by raising the Z stage 303 when it is changed from the overhead inspection to the oblique inspection, the disposition of the optical path length correction elements 503 allows the overhead inspection to be performed at the same stage height that is used while detecting scattered light from the image sensor detection area 4 for the oblique inspection of the image sensor, thus obviating the need for the stage height correction quantity and a coarse adjustment mechanism.

It is desired that the optical path length correction element 503 have an image aberration correction function. The optical path length correction element 503 can have its beam emitting surface formed in an aberration correcting curve to prevent a degradation of imaging performance. This allows for the correction of aberration of light passing through peripheral portions of the high NA detection optic system, resulting in a reduced distribution of strength of image received in the image sensor and therefore reduced sensitivity variations.

### Third Embodiment

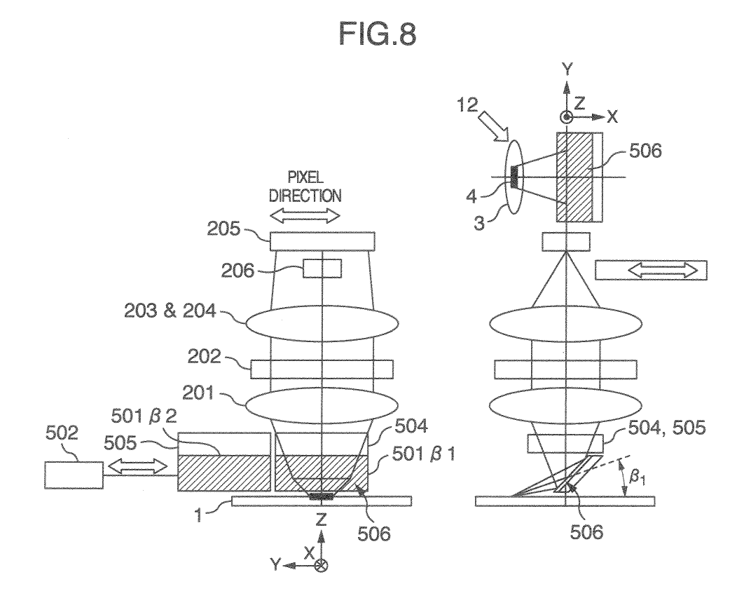

Referring to FIG. 8, a third embodiment of the oblique inspection according to this invention will be described. The object of this embodiment is to realize a method capable of the overhead inspection and the oblique inspection without changing the stage height by setting the stage height during the overhead inspection and the stage height during the oblique inspection equal using the detection optic system and making the focus height of the auto-focus system follow within a pull-in range. For this purpose, it is desired that an optical path length correction element 504 or 505 be disposed between the planar reflection mirror 501 and the detection optic system 200 to extend the optical path length. The optical path length can be extended by as much as (1-1/refractive index) times the optical path length passing through the correction element. FIG. 8 shows a construction in which two planar reflection mirrors 501 set at different angles, designed to direct scattered lights with two elevation angles of β1 and β2 to the detection lens 201, can be moved in a direction of the blank arrow by the switching mechanism 502 to switch between the two detection elevation angles. The optical path length correction elements 504 and 505 are provided over these two planar reflection mirrors 501, respectively. Also, the optical path length correction elements 504 and 505 need to have their light emitting surfaces formed aspherical so as not to degrade the imaging performance. This allows for the correction of aberration of light passing through peripheral portions of the high NA detection optic system, resulting in a reduced distribution of strength of image received in the image sensor 205 and therefore reduced sensitivity variations. In this embodiment, since the optical path length correction element is shaped like a lens, when compared with the second embodiment, it can easily be formed aspherical. However, because of its short optical path, the third embodiment has a small quantity of correction, so that reducing the elevation angle of β of the oblique detection system will result in an insufficient correction quantity. Therefore, at low elevation angles of β it is desired that the prism type of the second embodiment be used.

### Fourth Embodiment

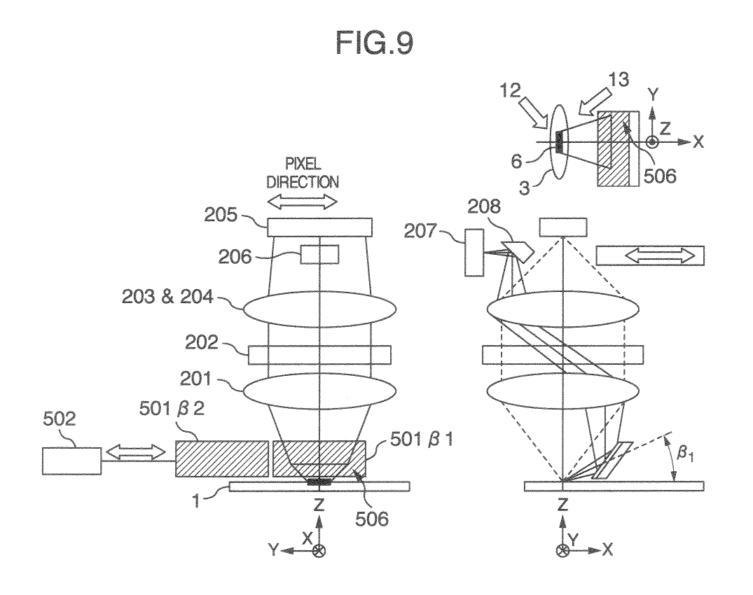

Referring to FIG. 9, a fourth embodiment of the oblique inspection according to this invention will be explained. The object of this embodiment is to realize a method capable of inspecting light from the same inspection area (in this example, an inspection area 6) in a single inspection operation using one or more image sensors. That is, this method allows the light from the image sensor detection area 6 to be detected by both of the image sensor 205 for the overhead inspection and an image sensor 207 added for the oblique inspection. To this end, it is desirable that the position of the planar reflection mirror 501 be shifted from the optical axis of the detection optic system 200 to cause the light reflected by the planar reflection mirror 501 to enter into a peripheral portion of the detection lens 201. An optical path branching planar reflection mirror 208 is placed in the optical path of the light reflected by the planar reflection mirror 501 so as to reflect the obliquely scattered light coming from the image sensor detection area 6 by the optical path branching planar reflection mirror 208 and focus it on the image sensor 207 for oblique detection. In this case, the optical path for oblique inspection differs from the optical path for overhead inspection (dashed line). So, if the optical path branching planar reflection mirror 208 is placed outside the overhead inspection area (i.e., outside the optical path for overhead inspection), the overhead inspection and the oblique inspection can be done at the same time. It is also possible to add an optical path length correction element to the oblique detection optic system, as in the second or third embodiment.

An effect of the simultaneous inspection is reduction of inspection time. Two kinds of signal with different detection elevation angles can be taken in and execution of inspection while at the same time performing calculation is possible, minimizing the hardware memory capacity and reducing the time and load of software processing. In this embodiment, by differentiating the inspection illumination light 12 and the inspection illumination light 13 from each other in wavelength and/or polarization, it is possible to obtain information on different signal strengths in a single inspection operation using two image sensors 205 and 207. Since light scattered from a defect produces different signal strengths according to the wavelength, polarization, or detection angle of elevation, information on defect category can be extracted with higher precision by using a signal strength ratio between the two image sensors 205 and 207 as a characteristic quantity.

### Fifth Embodiment

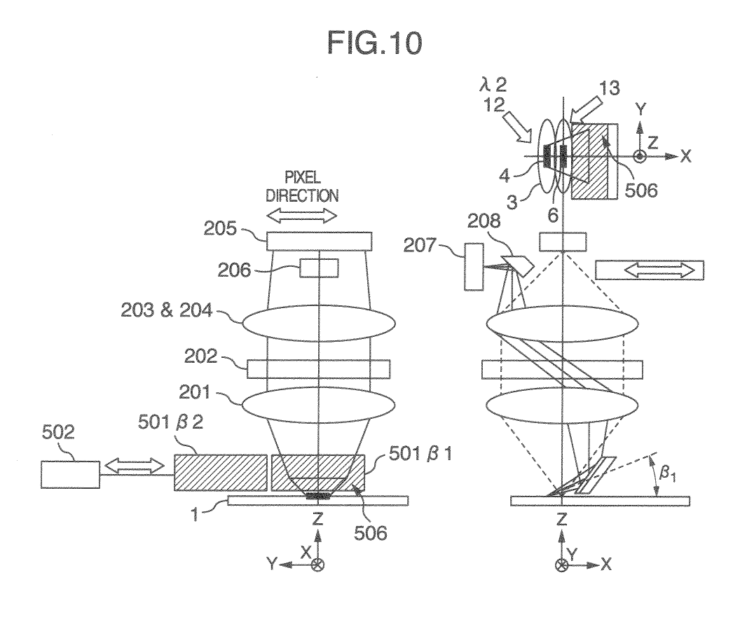

Referring to FIG. 10, a fifth embodiment of the oblique inspection according to this invention will be explained. The object of this embodiment is to realize a method capable of simultaneously executing both the overhead inspection that detects light from the image sensor detection area 6 with the image sensor 205 and the oblique inspection that detects light from the image sensor detection area 4 with the image sensor 207. To this end, it is desirable that the position of the planar reflection mirror 501 be shifted from the optical axis of the detection optic system 200 to cause the light reflected by the planar reflection mirror 501 to enter into a peripheral portion of the detection lens 201. It is also possible to add an optical path length correction element to the oblique detection optic system, as in the second or third embodiment. The difference from the fourth embodiment is that the image sensor detection area 4 for oblique inspection is placed at a position shifted from the image sensor detection area 6 for overhead inspection. To focus the image sensor detection area 4 on the image sensor 207, which is a sensor for oblique inspection, the optical path branching planar reflection mirror 208 is placed in the optical path of light reflected by the planar reflection mirror 501 to branch the light. At this time, as the optical path for overhead inspection is the one indicated by a dashed line, if the optical path branching planar reflection mirror 208 is placed outside the overhead inspection area (i.e., outside the optical path for overhead inspection), the overhead inspection and the oblique inspection can be done at the same time.

An effect of the configuration described above is reduction of inspection time. Two kinds of signal with different detection elevation angles can be taken in and execution of inspection while at the same time performing calculation is possible, minimizing the hardware memory capacity and reducing the time and load of software processing. A difference in an effect from the fourth embodiment is shifting the image sensor detection area 4 for oblique inspection from the image sensor detection area 6 for overhead inspection and bringing closer to the optical axis of the detection optic system 200 than in the fourth embodiment the position at which light reflected by the planar reflection mirror 501 enters into the detection lens 201 to narrow the field of view of the detection optic system 200 and minimize a degradation in the imaging performance for passing through the lens periphery. Further, the illumination direction, angle of elevation, polarization and wavelength can be selected as the illumination condition so that light can be focused on a plurality of image sensors for inspection. In this embodiment, by differentiating the inspection illumination lights 12 and 13 from each other in direction, angle of elevation, wavelength and/or polarization as in the fourth embodiment, it is also possible to obtain information on different signal strengths in a single inspection operation using the two image sensors 205 and 207. Since light scattered from a defect produces different signal strengths according to the wavelength, polarization, or detection angle of elevation, information on defect category can be extracted with higher precision by using a signal strength ratio between the two image sensors 205 and 207 as a characteristic quantity.

### Sixth Embodiment

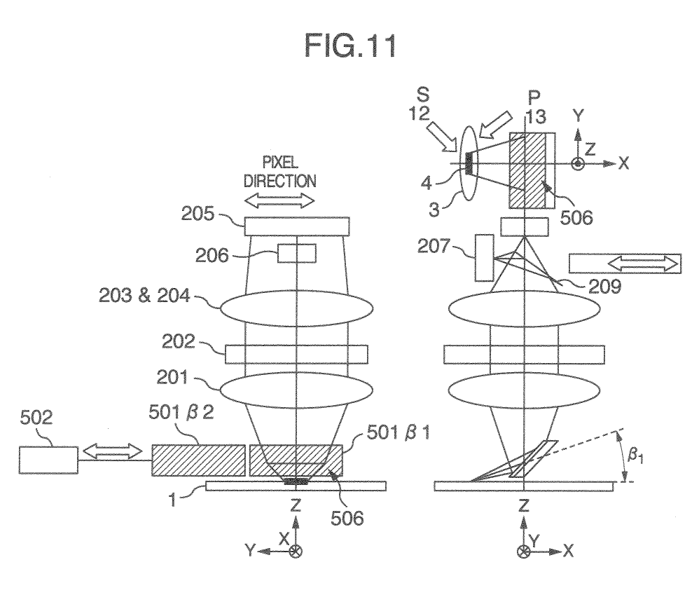

Referring to FIG. 11, a sixth embodiment of the oblique inspection according to this invention will be explained. The object of this embodiment is to realize a method which is characterized in detection of the image sensor detection area 4 by two sensors at the same time when a polarization is selected as the illumination condition. To this end, it is preferred that the image sensor detection area 4 be irradiated with two kinds of polarized light, which is P-polarized light and S-polarized light, and that the optical path is branched by a polarizing beam splitter 209 so that the S-polarized light and the P-polarized light can be detected by the respective image sensors 205 and 207. A beam spot 3 is formed with respect to the image sensor detection area 4 which is located at a position offset in parallel to the Y axis from the optical axis of the detection lens 201. In this embodiment, the inspection illumination light 12 is S-polarized and the inspection illumination light 13 is P-polarized. The light obtained from the image sensor detection area 4 is reflected into the detection lens 201 by the reflecting surface 506 of the planar reflection mirror 501 so inclined that the detection angle of elevation selected by the mirror switching mechanism 502 becomes β1 or β2. The light, from which pattern noise is removed by the spatial filter 202 placed at a Fourier transform plane of the detection lens 201, is imaged onto the image sensor 205 at a predetermined magnification by the image formation lens 203 and the zoom lens group 204. The image sensor detection area 4 or the surface of the spatial filter 202 can be observed by the observatory optic system 206. In this embodiment, the polarizing beam splitter 209 is inserted between the detection optic system 200 and the image sensor to split the optical path so that the images are formed on the two separate image sensors 207 and 205.

According to the above construction, since the signal strength of light scattered from a defect varies depending on the direction of polarization, a defect categorization becomes possible based on a signal strength ratio by splitting the light coming from the same defect with the polarizing beam splitter 209 and focusing two beams of different polarization components on the two image sensors 205 and 207. When the polarizing beam splitter 209 is replaced with an element capable of wavelength separation, information on two kinds of signal strength can be obtained simultaneously in a single inspection operation by differentiating the wavelengths of the inspection illumination lights 12 and 13. Since light scattered from a defect produces different signal strengths according to the wavelength, polarization, or detection angle of elevation, information on defect category can be extracted with higher precision by using a signal strength ratio between the two image sensors 205 and 207 as a characteristic quantity.

### Seventh Embodiment

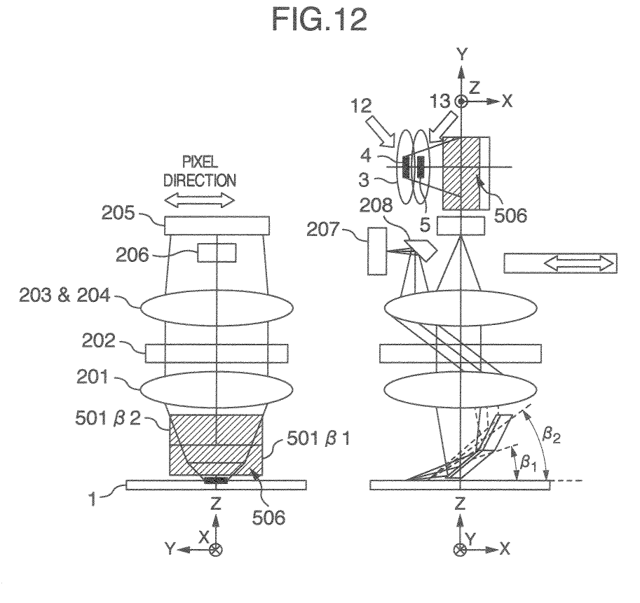

Referring to FIG. 12, a seventh embodiment of the oblique inspection according to this invention will be explained. The object of this embodiment is to realize a method that is characterized in detection using two illumination angles of elevation at the same time. For this purpose, it is desired that two planar reflection mirrors 501 with different angles β1 and β2 be inserted simultaneously in the optical path from the image sensor detection area 4 or 5 to the detection lens 201 between the detection lens 201 and the substrate to be inspected 1. In this embodiment a beam spot 3 of the inspection illumination light 12 is formed with respect to the image sensor detection area 4 which is located at a position offset in parallel to the Y axis from the optical axis of the detection lens 201. The light obtained from the image sensor detection area 4 is reflected into the detection lens 201 by the reflecting surface 506 of the planar reflection mirror 501 so inclined that the detection angle of elevation is 131. The light, which is reflected by the planar reflection mirror 501 and from which pattern noise is removed by the spatial filter 202 placed at a Fourier transform plane of the detection lens 201, is imaged onto the image sensor 205 at a predetermined magnification by the image formation lens 203 and the zoom lens group 204. The image sensor detection area 4 or the surface of the spatial filter 202 can be observed by the observatory optic system 206. On the other hand, a beam spot 3 of the inspection illumination light 13 is formed with respect to the image sensor detection area 5 which is located at a position offset in parallel to the Y axis from the optical axis of the detection lens 201. The light obtained from the image sensor detection area 5 is reflected into the detection lens 201 by the reflecting surface 506 of the planar reflection mirror 501 as a mirror which is so inclined that the detection angle of elevation is β2. By inserting the optical path branching planar reflection mirror 208 between the detection optic system 200 and the image sensor, the path of light coming from the image sensor detection area 5 is branched and imaged onto the image sensor 207.

With the above construction, since lights obtained at different angles from the image sensor detection areas 4 and 5 pass through different positions in the detection optic system 200 and therefore can be imaged onto the two image sensors 205 and 207, the oblique inspection of the light obtained from a defect can be made at two angles of elevation simultaneously in a single inspection operation. So, by combining the oblique inspection of this embodiment with the overhead inspection, a high NA detection with an NA of 0.9 or higher, for example, can be done, allowing almost all of light scattered from the defect to be picked up and therefore increasing the number of species of defects and the number of defects to be detected. Further, by differentiating the inspection illumination lights 12 and 13 from each other in wavelength and/or polarization as in the fourth embodiment, it is possible to obtain information on different signal strengths from two image sensors 205, 207 in a single inspection operation. Since light scattered from a defect produces different signal strengths according to wavelength, polarization, or detection angle of elevation, information on defect category can be extracted with higher precision by using a signal strength ratio between the two image sensors 205 and 207 as a characteristic quantity.

### Eighth Embodiment

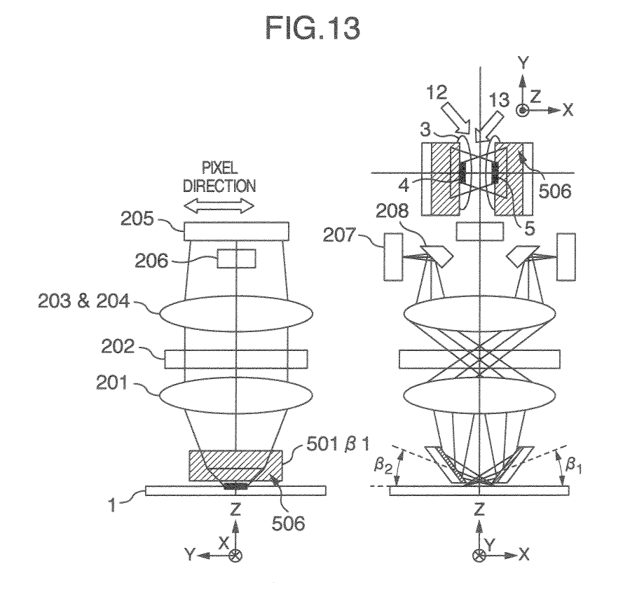

By referring to FIG. 13, an eighth embodiment of the oblique inspection according to this invention will be explained. The object of this embodiment is to realize capability of two kinds of oblique inspection simultaneously in a single inspection operation disposing two sets of mechanism arranged in an opposing manner that can perform the oblique inspection with a shift of the detection area in a direction (in this example, an X-axis direction) perpendicular to the pixel direction of the image sensor (a longitudinal direction). That is, the inspection illumination lights 12 and 13 are desirably thrown onto the image sensor detection areas 4 and 5 respectively by disposing two opposing planar reflection mirrors 501, that are set at different angles (or their angles may be set equal), between the detection lens 201 and the substrate to be inspected 1. The paths of scattered lights due to the inspection illumination lights 12 and 13 bent by these two planar reflection mirrors 501 are separated from each other in the detection optic system 200 and can be imaged onto the image sensors 205 and 207, respectively. A beam spot 3 of the inspection illumination light 13 is formed with respect to the image sensor detection area 4, which is located at a position offset in parallel to the Y axis from the optical axis of the detection lens 201. The light obtained from the image sensor detection area 4 is reflected into the detection lens 201 by the reflecting surface 506 of the planar reflection mirror 501 so inclined that the detection angle of elevation is β1. On the other hand, another beam spot 3 of the inspection illumination light 12 is formed with respect to the image sensor detection area 5, which is located at a position offset in parallel to the Y axis from the optical axis of the detection lens 201. The light obtained from the image sensor detection area 5 is reflected into the detection lens 201 by the reflecting surface 506 of the planar reflection mirror 501 so inclined that the detection angle of elevation is β2. Optical paths of the lights reflected by the respective planar reflection mirrors 501, which pass through the detection optic system 200, are branched by optical path branching planar reflection mirrors 208 inserted between the detection optic system 200 and the image sensors, respectively, and their images are formed on different image sensors 207, respectively.

Further, by inserting and retracting the planar reflection mirror 501 by the switching mechanism 502 (see FIG. 6), the overhead inspection that forms an image on the image sensor 205 can be made. The light, from which pattern noise is removed by the spatial filter 202 placed at a Fourier transform plane of the detection lens 201, is imaged onto the image sensor 205 at a predetermined magnification by the image formation lens 203 and the zoom lens group 204. The detection area or the surface of the spatial filter 202 can be observed by the observatory optic system 206.

Also in this example, by differentiating the inspection illumination lights 12 and 13 from each other in wavelength and/or polarization as in the fourth embodiment, information on different signal strengths can be obtained from the two image sensors 207 at the same time in one inspection operation. Since light scattered from a defect produces different signal strengths for different wavelengths, polarizations, or detection angles of elevation, a ratio of signal strengths of the two image sensors 207 can be used as a characteristic quantity to extract the defect category information with high precision.

### Ninth Embodiment

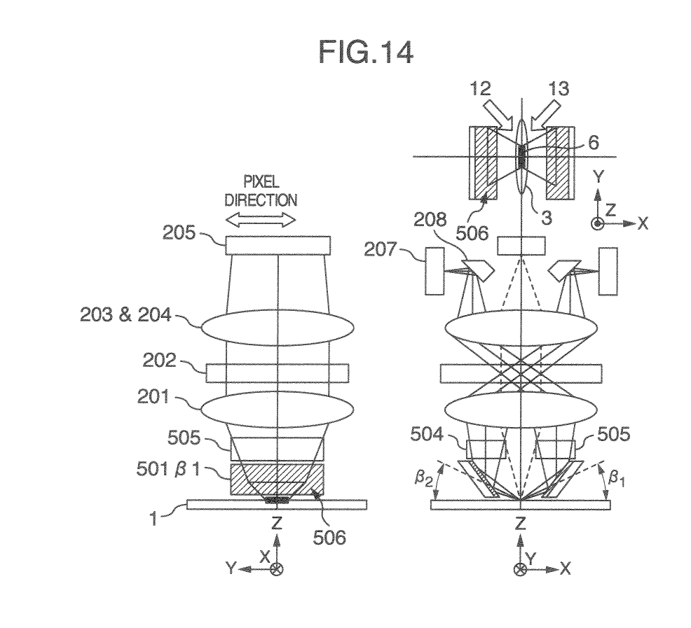

Referring to FIG. 14, a ninth embodiment of the oblique inspection according to this invention will be explained. The object of this embodiment is to realize a method which allows three inspections to be performed simultaneously in a single inspection operation: two kinds of oblique inspection using two sets of oblique inspection image sensors by arranging two sets of mechanisms capable of oblique inspection to oppose each other and an overhead inspection using an overhead inspection image sensor.

To this end, it is desired that a beam spot 3 be formed with respect to the image sensor detection area 6, which is located at a position on the optical axis of the detection lens 201 and parallel to the Y axis by disposing two opposing planar reflection mirrors 501, that are set at different angles (or their angles may be set equal), between the detection lens 201 and the substrate to be inspected 1 and throwing the inspection illumination lights 12 and 13 onto the image sensor detection area 6. The paths of scattered lights due to the inspection illumination lights 12 and 13 bent by these two planar reflection mirrors 501 are separated in the detection optic system 200, so that scattered lights due to the inspection illumination lights 12 and 13 can be imaged onto the corresponding oblique inspection image sensors 207 and overhead inspection image sensor 205, respectively. This realizes three inspection paths, allowing for simultaneous execution of two oblique inspections and one overhead inspection.

In the first optical path, the light obtained from the image sensor detection area 6 is reflected into the detection lens 201 by the reflecting surface 506 of the planar reflection mirror 501 so inclined that the detection angle of elevation is β1. The light, from which pattern noise is removed by the spatial filter 202 placed at a Fourier transform plane of the detection lens 201, is imaged onto the image sensor 205 at a predetermined magnification by the image formation lens 203 and the zoom lens group 204. The image sensor detection area 6 or the surface of the spatial filter 202 can be observed by the observatory optic system 206. In the second optical path, the light obtained from the image sensor detection area 6 is reflected into the detection lens 201 by the reflecting surface 506 of the planar reflection mirror 501 so inclined that the detection angle of elevation is 132. In the third optical path, the light coming from the image sensor detection area 6 is directly brought into the detection lens 201. The first optical path and the second optical path that pass through the detection optic system 200 are imaged onto different image sensors 207 by separate optical path branching planar reflection mirrors 208 placed between the detection optic system 200 and the image sensors, respectively. Beside, the third optical path is directly imaged onto the image sensor 205 through the detection optic system 200. Further, by disposing the lens-type optical path length correction elements 504, 505 between the detection lens 201 and the respective planar reflection mirrors 501, it is possible to focus the three inspection light paths onto the object plane and adjust the Y direction magnifications. On the other hand, by differentiating the inspection illumination light 12 and the inspection illumination light 13 from each other in wavelength and polarization, as in the fourth embodiment, information on different signal strengths from the image sensor 205 and the two image sensors 207 can be obtained in a single inspection operation. Since the scattered light from a defect varies in signal strength according to wavelength, polarization and/or detection angle of elevation, the ratio of three sensor signal strengths can be used as a characteristic quantity to extract the defect category information with high precision.

### Tenth Embodiment

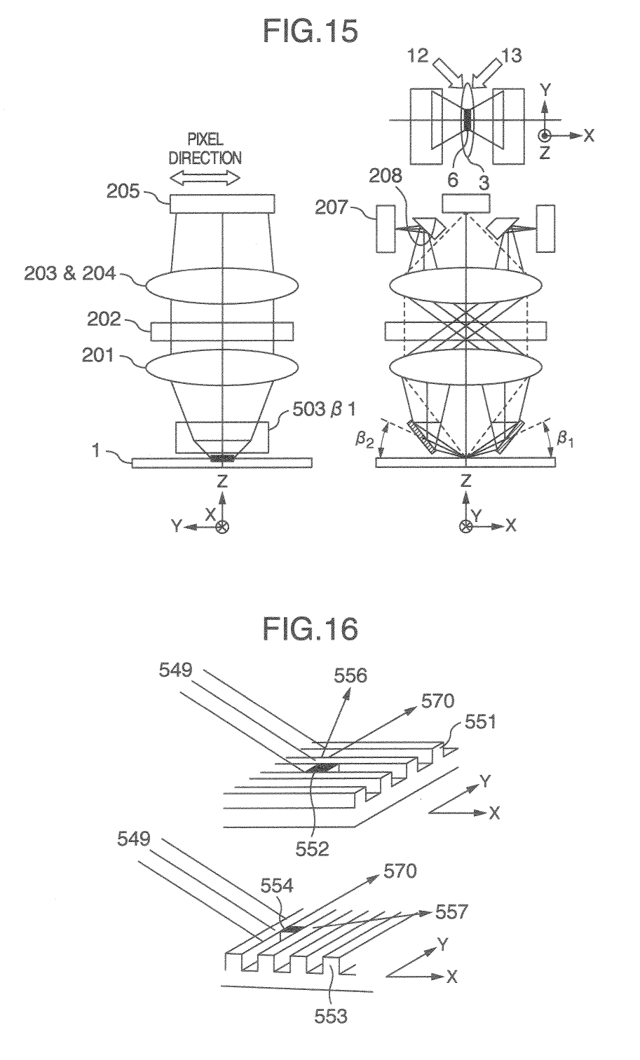

Referring to FIG. 15, a tenth embodiment of the oblique inspection according to this invention will be explained. As opposed to the ninth embodiment, this embodiment is an example where the oblique inspection is executed with a prism-type planar reflection mirror. That is, a beam spot 3 is formed with respect to the image sensor detection area 6, which is located at a position on the optical axis of the detection lens 201 and parallel to the Y axis by throwing the inspection illumination lights 12 and 13. In a first optical path, the light obtained from the image sensor detection area 6 irradiated with the inspection illumination light 13 is reflected by a reflecting surface of the prism-type optical path length correction element 503 so inclined that the detection angle of elevation is 131, and enters the detection lens 201. In the second optical path, the light obtained from the image sensor detection area 6 irradiated with the inspection illumination light 12 is reflected by a reflecting surface of the opposite, prism-type optical path length correction element 503 so inclined that the detection angle of elevation is 132, and enters the detection lens 201. In the third optical path, the light coming from the image sensor detection area 6 is directly brought into the detection lens 201. By disposing the optical path length correction elements 503 between the detection lens 201 and the substrate to be inspected 1, the three inspection light paths can be focused onto the object plane and the Y-axis direction magnifications can also be adjusted. The first and second optical paths that have passed through the detection optic system 200 are reflected by separate optical path branching planar reflection mirrors 208 inserted between the detection optic system 200 and the image sensors and imaged onto the corresponding image sensors 207, respectively. Beside, the third optical path is directly imaged onto the image sensor 205 through the detection optic system 200. The light, from which pattern noise is removed by the spatial filter 202 placed at a Fourier transform plane of the detection lens 201, is imaged onto the image sensor 205 at a predetermined magnification by the image formation lens 203 and the zoom lens group 204. Also, the image sensor detection area 6 or the surface of the spatial filter 202 can be observed by the observatory optic system 206.

With the above construction, by differentiating the inspection illumination lights 12 and 13 from each other in wavelength and/or polarization as in the fourth embodiment, information on different signal strengths can be obtained from the image sensor 205 and the two image sensors 207 simultaneously in one inspection operation. Since light scattered from a defect produces different signal strengths for different wavelengths, polarizations, or detection angles of elevation, the ratio of signal strengths of the three image sensors 205 and 207 can be utilized as a characteristic quantity to extract the defect category information with high precision.

Here, a pattern and a defect formed on the substrate to be inspected 1 that are to be detected by the defect inspection device according to the above respective embodiments will be described in further detail, referring to FIG. 16.

The pattern formed on the substrate to be inspected 1 has mainly orthogonal, X and Y directions. FIG. 16 illustrates a Y-direction linear pattern 553 formed elongated in the Y direction and an X-direction pattern 551 formed elongated in the X direction. Generally, patterns are formed by exposure, development, and etching processes. A short-circuit defect caused by variations in process condition, such as a focus shift during exposure for instance, can be a shortest distance between lines. For example, a short-circuit defect in the Y-direction pattern 553 is presented as a Y-direction pattern defect 554 between lines adjoining in the X direction and a short-circuit defect in the X-direction pattern 551 as an X-direction pattern defect 552 between lines adjoining in the Y direction. When an oblique illumination with an XZ plane used as a plane of incidence is performed to inspect the X-direction pattern defect 552 and the Y-direction pattern defect 554, this oblique illumination is an orthogonal illumination for the Y-direction pattern 553 and a parallel illumination for the X-direction pattern 551. In this case, although the X-direction pattern defect 552 formed in the X-direction pattern 551 parallel to the illumination light 549 can secure a sufficient scattering cross section, the Y-direction pattern defect 554 formed in the Y-direction pattern 553 perpendicular to the illumination lies in the shade of the Y-direction pattern 553 and the defect 554 receives only a small amount of light. So, the amount of scattered light from the Y-direction pattern defect 554 is small, rendering the detection of the Y-direction pattern defect 554 difficult. On the other hand, when the plane of incidence is tilted with respect to the YZ plane, a percentage of the portion of the Y-direction pattern defect 554 which lies in the shade of the Y-direction pattern 553 viewed from the illumination direction is reduced and the amount of light striking the Y-direction pattern defect 554. This in turn increases the amount of scattered light from the Y-direction pattern defect 554, facilitating the detection of the Y-direction pattern defect 554. When the plane of incidence is inclined with respect to the YZ plane, the illumination light 549 produces a scattered light distribution 556 from the X-direction pattern from the X-direction pattern 551, a scattered light distribution from the defect 570 from the X-direction pattern defect 552 or the Y-direction pattern defect 554, and a scattered light distribution 557 from the Y-direction pattern from the Y-direction pattern 553.

As described above, tilting the illumination direction with respect to the X axis and/or Y axis can facilitate the detection of short-circuit defects between lines and the like. It is also noted that, depending on the illumination angle of elevation, the shape of defect easily detectable can vary, such as convex defects like foreign matters and concave defects like scratches. It is, therefore, desirable to make a structure adjustable not only the illumination direction but also the illumination angle of elevation (or detection angle of elevation) so that the condition in which the inspection S/N becomes maximum can be selected according to the pattern geometry of the substrate to be inspected and the shape of a defect to be inspected.

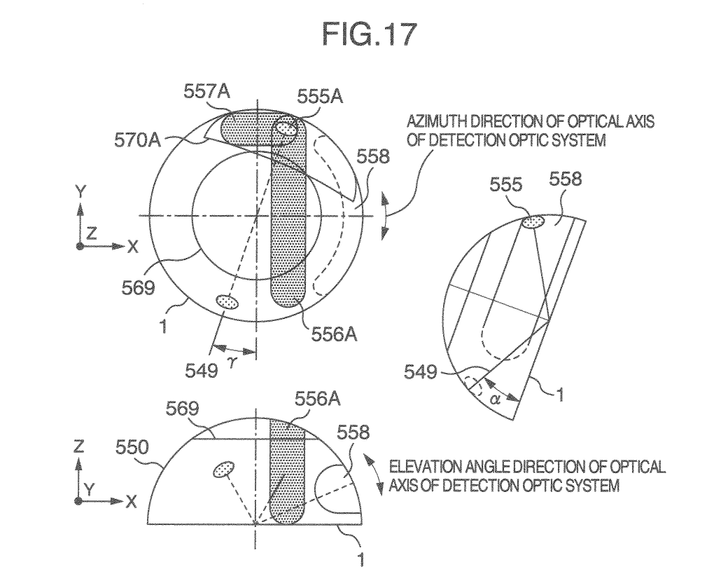

FIG. 17 shows a relationship between the direction in which to detect scattered light and the illumination direction in the detection optic system 200. When a hemisphere having its center (origin) in a central part of a beam spot of the illumination light 549 is assumed to be on the substrate to be inspected 1, FIG. 17 shows a plan view (XY plane) of an imaginary hemisphere 550, a side view as seen from the Y-axis direction (XZ plane), and a side view as seen from a direction perpendicular to the illumination direction of the illumination light 549. The scattered light distribution 556 from the X-direction pattern, the scattered light distribution 557 from the Y-direction pattern and the scattered light distribution 570 from the defect (see FIG. 16), all of what are scattered lights from a defect and the pattern, spread hemispherically and enter regions 556A, 557A, and 570A on the imaginary hemisphere, respectively as shown in FIG. 17. Reference number 569 in the figure represents a projection of an aperture of the overhead detection system onto the imaginary hemisphere 550. The illumination direction (plane of incidence) of the illumination light 549 is inclined at an angle of y with respect to the YZ plane and the specular reflected light from a horizontal flat portion on the substrate to be inspected 1 enters a region 555A that is symmetrical to a line extending from the apex of the imaginary hemisphere 550 down to the origin (Z axis), as shown in FIG. 17. The regions 556A and 557A, into which the scattered light distribution 556 from the X-direction pattern and the scattered light distribution 557 from the Y-direction pattern enter, shift depending on the angle γ and the elevation angle α of the illumination light 549.

Assuming a case where the substrate to be inspected 1 has a mixture of normal patterns extending in an X-axis direction and a Y-axis direction, in FIG. 17, the scattered light 556 from a pattern elongated in the X-axis direction collect mainly in the region 556A, which includes the region 555A that the specular reflected light from the flat portion enters. This region 556A extends in the Y-axis direction. Also, the scattered light 557 from the Y-direction pattern 553 collect in the region 557A, which includes the specular reflected light 555A from the flat portion. This region 557A extends in the X-axis direction. On the other hand, the scattered light 570 coming from a defect shaped differently from the patterns enter the region 570A that differs from those regions receiving the scattered light 556 and 557 from the patterns. This region 570A overlaps, in addition to the region 555A, a part or whole of the regions 556A and 557A depending on the angle γ of the illumination light 549. FIG. 17 shows an example case in which the forward scattered light strength of the scattered light 570 from a defect is strong.

In this defect inspection device, in order to detect only the scattered light 570 from a defect, the detection optic system 200 and the planar reflection mirror 501 are arranged so as to be able to capture as much scattered light 570 as possible that enters part of the region 570A which do not overlap the regions 556A and 557A that can receive the scattered lights 556 and 557 from the normal patterns. For example, as shown in FIG. 17, the detection optic system is so disposed that an aperture 558 projected onto the imaginary hemisphere 550 overlaps only the region 570A, not the regions 556A or 557A. Since the area of the aperture 558 overlapping only the region 570A varies depending on the angle γ of the inspection illumination light 549 and the manner the aperture 558 of the detection optic system is arranged, it is desired to determine the angle γ and the arrangement and size of the aperture 558 in a way that makes the area of the aperture 558 overlapping only the region 570A as large as possible.

The NA (numerical aperture) in the elevation angle direction (XZ plane) of the optical axis of the detection optic system is limited to a range that can avoid entrance of the scattered lights 556 and 557 from the patterns. Therefore, in magnifying the amount of the scattered light to be captured, it is effective to enlarge the aperture 558 in the azimuth direction with reference to the optical axis of the detection optic system to effectively capture only the scattered light 570 from a defect.

Conventionally, magnifying the NA of the detection optic system at a low angle of elevation has been structurally difficult. In the embodiments of this invention, by limiting the aperture 558 of the optical axis of the detection optic system to the direction of elevation angle, it is possible to magnify the NA up to the full aperture (e.g., NA 0.6, NA 0.8, and the like), i.e., the equivalent of the NA of the detection lens in the azimuth direction of the optical axis of the detection optic system. In a configuration where the optical axis is bent by the planar reflection mirror as in the respective aforementioned embodiments, the aperture 558 can be magnified up to the NA of the detection lens 201 in the image sensor pixel direction. This allows the capture of the scattered light from the normal patterns to be minimized while at the same time increasing the scattered lights from a defect that are to be captured by the detection optic system, thereby improving the inspection S/N.

The setting of an aperture in a way that differentiates an NA value of the detection optic system in the elevation angle direction of the optical axis of the detection optic system from a value in the horizontal direction is not necessarily limited to the method using the mirror. A configuration employing another detection lens may also be used. Such a configuration is described in the next eleventh embodiment.

### Eleventh Embodiment

FIG. 20 is a schematic diagram of an eleventh embodiment of the oblique inspection according to this invention. That is, in this embodiment, a low elevation angle detection optic system 573 for oblique inspection is disposed in addition to the aforementioned detection optic system 200. The construction of the low elevation angle detection optic system 573 is roughly similar to that of the detection optic system 200. It is noted, however, that because a detection lens (object lens) 572 of the low elevation angle detection optic system 573 is spatially limited at its lower part by the substrate to be inspected 1 and at its upper part by the detection optic system 200, the detection lens 572, as seen from the arrow A in the figure, has its upper and lower parts cut off to limit the aperture in the elevation angle direction of the optical axis. This is one of possible constructions this embodiment can take.

### Twelfth Embodiment

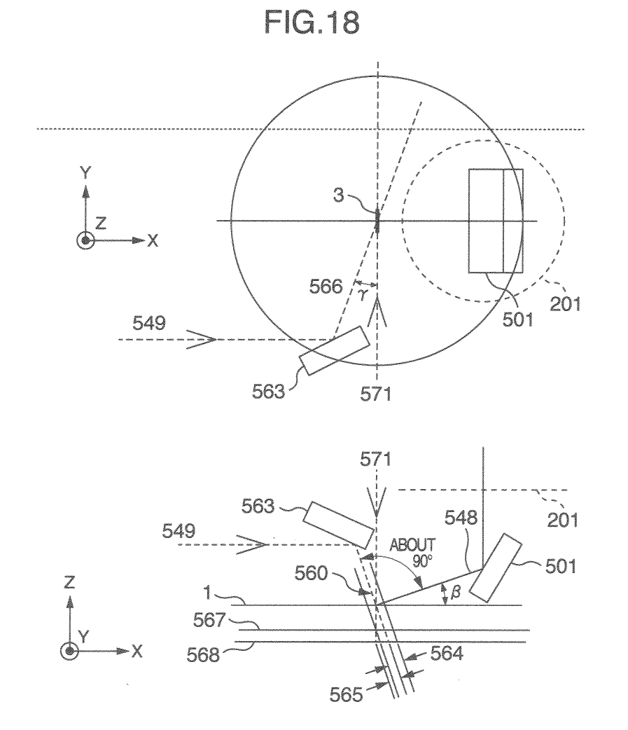

FIG. 18 is a schematic diagram of a twelfth embodiment of the oblique inspection according to this invention. This embodiment represents an optimal layout of the illumination optic system with respect to the detection optic system for oblique inspection. In this embodiment an illumination mirror 563 that reflects and bends an irradiated illumination light is provided in the illumination optic system. As shown in a plan view of FIG. 18, the illumination light 549 irradiated from the illumination optic system is bent by the illumination mirror 563 to form a beam spot 3 onto the substrate to be inspected 1 through an angle γ to the Y axis, as seen from above. For example, as in the first embodiment, the detection optic system 200 has the planar reflection mirror 501 and the detection lens 201 disposed on the X axis to capture scattered light from a defect. When viewed from the side (from the Y-axis direction), the illumination light 549 is bent by the illumination mirror 563 and thrown onto the substrate to be inspected 1 at an illumination angle of elevation a, which forms an angle of about 90 degrees with the detection angle of elevation β of the detection optic system 200.

With this construction, the substrate to be inspected 1 can be prevented from getting out of focus if the height of the substrate to be inspected 1 changes, by arranging the illumination mirror 563 so that the angle which the plane having therein the optical axis of an illumination flux and the longitudinal axis of the beam spot 3 (Y axis) forms with the optical axis of a flux of scattered light incident on the detection optic system 200 is almost 90 degrees. That is, the plane having therein the optical axis of the illumination flux and the longitudinal axis of the beam spot 3 is a focus plane 560 of the detection optic system 200. Since the optical axis of the illumination light 549 reflected by the illumination mirror 563 lies on the focus plane 560, when the height of the substrate to be inspected 1 changes, the position on the substrate to be inspected 1 of the beam spot 3 of the illumination light 549 moves along the focus plane 560. As described above, the beam spot 3 is always on the focus plane 560, so that as long as the focus of the detection optic system 200 is on the beam spot 3, the detection optic system 200 remains focused on the beam spot 3 of the illumination light 549 regardless of the height of the substrate to be inspected 1.

As for an illumination light at other angle of elevation, for example, an illumination light 571 from the YZ plane, its beam spot is formed on an intersecting line between the YZ plane and the substrate to be inspected 1 and moves along the YZ plane as the substrate to be inspected 1 moves up or down; therefore, the beam spot of the illumination light 571 may get out of a focal depth 564 of the detection optic system 200. When the substrate to be inspected 1 lowers to the height 568, for example, the beam spot of the illumination light 571 gets out of the focal depth 564, bringing the scattered lights of the illumination light 571 out of focus by an amount 565. In the example of FIG. 17, when the substrate to be inspected 1 is lowered below the height 567, the beam spot of the illumination light 571 gets out of the focal depth 564.

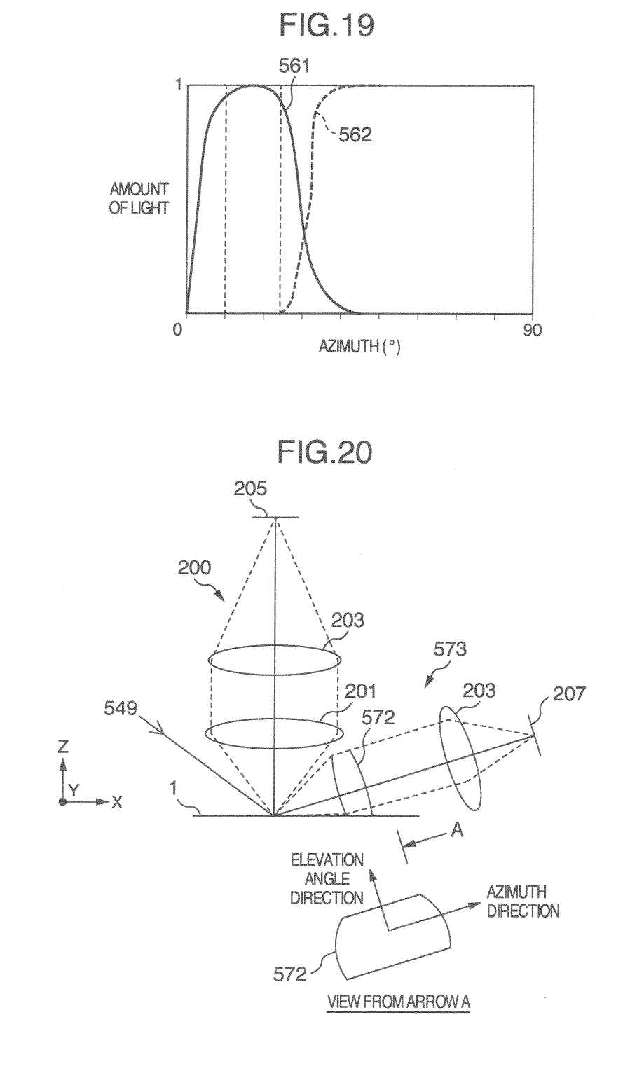

An appropriate range of the illumination direction γ in the twelfth embodiment will be explained by referring to FIG. 19.

Since, in the side view described above, the angle, which is formed between the plane having therein the optical axis of the illumination flux and the longitudinal axis of the beam spot 3 and the optical axis of the detection optic system, is about 90 degrees, the illumination direction γ can be determined from the following equation 1, where α is an angle of elevation of the plane having therein the optical axis of the illumination flux and the longitudinal axis of the beam spot 3 and β is a low angle of elevation of the detection optic system.

sin γ=tan α·tan β (Equation 1)

A profile 561 shown in FIG. 19 represents a distribution of the amount of the scattered light captured by the oblique detection optic system for the detection angle of elevation β. The distribution of the amount of the scattered light is shown by converting the detection angle of elevation β into the illumination direction γ by (Equation 1). Another profile 562, on the other hand, represents a distribution of the amount of the scattered light from the pattern captured by the oblique detection optic system for the illumination direction γ. Furthermore, because of limitations of the actual mounting, the detection angle of elevation β needs to be set in a range in terms of the illumination direction γ, which is converted from β, as roughly γ>10°. To further avoid influences of the pattern-scattered light, it is limited to a range of roughly γ<25° based on the profiles 561 and 562 of FIG. 19. It is, therefore, desired that the illumination direction γ be set close to 17.5°, the center value of between 10° and 25°.

In this embodiment described above, further modifications may be made within the technical philosophy of this invention.

### Thirteenth Embodiment

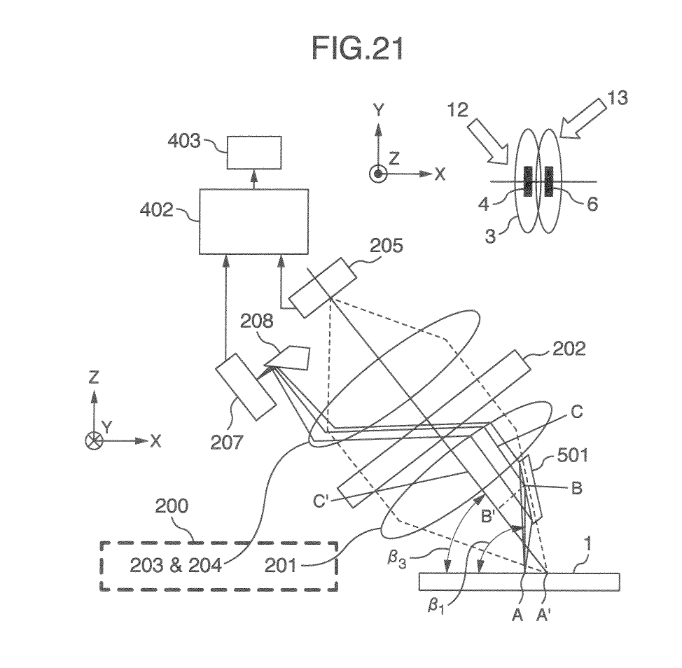

FIG. 21 is a schematic diagram of a thirteenth embodiment of the oblique inspection according to this invention. The object of this embodiment is to realize a method for executing a plurality of inspections simultaneously at different detection angles of elevation. The simultaneous inspection of this embodiment yields defects that can be detected by a plurality of inspections using light paths at different detection angles of elevation and process the obtained results in the same coordinate system in a single inspection operation, and the effect is to classify the defects according to the characteristics of brightness distribution over different detection angles of elevation.

FIG. 21 represents an embodiment in which there is no difference in the optical path length from the detection optic system 200 to the substrate to be inspected 1 between an inspection optical path using the reflection mirror 501 and an inspection optical path not using the reflection mirror 501 by tilting the optical axis of the detection optic system 200 with respect to the substrate to be inspected 1. That is, an overhead inspection optical path length between the substrate to be inspected 1 and the front principal point of the detection optic system 200, ABC, is equal to an oblique inspection optical path length AC′. So, the inspection using the reflection mirror 501 and the inspection not using the reflection mirror 501 have at the same heights their focuses on the substrate to be inspected, allowing simultaneous inspection to acquire a plurality of different inspection results at the same time in one inspection.

The overhead inspection optical path enters the reflection mirror 501 from a direction at an angle of β1=90° with respect to the substrate to be inspected 1 and the reflected light travels parallel to the optical axis of the detection optic system 200 to enter the detection lens 201. The outgoing light from the detection optic system 200 is reflected by the optical path branching planar reflection mirror 208 and imaged on the image sensor 207. The oblique inspection optical path enters the detection lens 201 at an elevation angle of β1 with respect to the substrate to be inspected 1 and the optical path outgoing from the detection optic system 200 is imaged on the image sensor 205. The detection angles of elevation β1 and β3 can be changed in a spatially limited range and by setting β1 and β3 in a recipe of the inspection conditions by moving the optical axis of the detection optic system and changing the angle of the reflection mirror by an actuator defects dependent on the detection angle of elevation are selectively inspected.

Since the overhead oblique inspections have the same magnification factor in the Y direction, the Y direction coordinate is common. In the X direction coordinate, because the image sensor detection areas 4 and 6 are offset, a correction by the amount of the offset is required. The inspection illumination light 12 illuminates the image sensor detection area 4. Required conditions for illumination are an intensity level of illumination, a uniformity of illumination distribution, and an illumination width. Because the image sensor is linear-shaped, the detection areas 4 and 6 can be applied an increased intensity of illumination by narrowing the beam width. In the oblique inspection, since the detection angle of elevation is β3 in the ZX plane, the focus is linearly shaped in the Y-axis direction. To enhance the illumination efficiency, therefore, the illumination width needs to be narrow in the X direction. When the image sensor is an integration type in the X direction, it detects an out-of-focus image with wide illumination width and the resolution of the detected image is degraded.

By differentiating the illumination conditions of wavelength, polarizing direction, angle of elevation, and direction between the inspection illumination light 12 and the inspection illumination light 13 as in the fourth embodiment, the inspection illumination lights 12 and 13 yield information of different signal strengths with the two image sensors 205 and 207 in a single inspection operation. Since scattered light from a defect varies in signal strength according to wavelength, polarization, or detection angle of elevation, defect category information is extracted by using the signal strength ratio of the image sensors 205 and 207 as a characteristic quantity.

### Fourteenth Embodiment

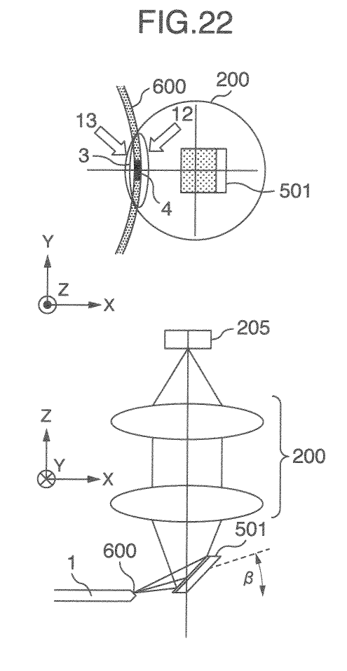

Referring to FIG. 22, a fourteenth embodiment of the oblique inspection according to this invention will be explained. The object of this embodiment is to realize a method characterized in a bevel inspection using a method of the oblique inspection using the planar reflection mirror. An effect of this method is being able to easily change the detection angle of elevation with respect to the bevel surface by setting the mirror at a desired inclination. A bevel portion 600 of a substrate to be inspected represents an inclined portion of an edge of the substrate to be inspected 1. By this inspection it is intended to find defects in the bevel portion, i.e., the state of the film, foreign matters, and damages, to prevent contaminations by flaked film and foreign contaminants from being carried over to the subsequent processes.

In this embodiment, the X stage 301 and the Y stage 302 in aforementioned FIG. 1 are operated to move the bevel portion to the detection area 4 and the theta (θ) stage 304 turns the substrate to be inspected 1 to scan the detection area 4 over the entire bevel portion. The inspection illumination lights 12 and 13 are used to form a beam spot 3 on the bevel portion. The reflected light generated from a common part of the bevel portion 600 and the image sensor detection area 4 is picked up by the detection optic system and imaged on the image sensor 205. The signal obtained is A/D-converted by the aforementioned signal processing portion 402 of FIG. 1 and processed by the threshold calculation process to find a desired defect.

### REFERENCE SIGNS LIST

1: Substrate to be inspected (wafer)
1a, 1b: Substrate to be inspected
1aa: Memory LSI chip
1ab: Memory cell area
1ac: Peripheral circuit area
1ad: Other area
1ba: LSI such as microcomputer
1bb: Register group area
1bc: Memory portion area
1bd: CPU core portion area
1be: Input/output portion area
3: Beam spot (illumination area)
4, 5, 6: Image sensor detection area
11-13: Inspection illumination light
100: Illumination optic system
101: Laser source
102: Concave lens
103: Convex lens
104: Illumination lens
110: First beam spot formation portion
120: Second beam spot formation portion
130: Third beam spot formation portion
200, 548: Detection optic system
201: Detection lens (object lens)
202: Spatial filter
203: Image formation lens
204: Zoom lens group
205, 207: Image sensor
206: Observatory optic system
208: Optical path branching planar reflection mirror
209: Polarizing beam splitter
210: Branch detection optic system
300: Stage portion
301-304: XYZθ stages
305: Stage controller
400: Control system
401: Control CPU portion
402: Signal processing portion
403: Display portion
404: Input portion
501: Planar reflection mirror
502: Switching mechanism
503, 504, 505: Optical path length correction element
506: Reflecting surface
549: Illumination light
550: Imaginary hemisphere
551: X-direction pattern
552: X-direction pattern defect
553: Y-direction pattern
554: Y-direction pattern defect
555: Point at which a specular reflected light intersects 550
556: Scattered light distribution from X-direction pattern
557: Scattered light distribution from Y-direction pattern
558: Aperture of high-NA detection system
560: Focus plane of detection system
561: Distribution of amount of scattered light of an example defect captured by detection optic system (low angle of elevation β of detection optic system is converted into φ)
562: Distribution of amount of scattered light from a pattern captured by detection optic system
563: Illumination mirror
564: Focal depth of detection optic system
565: Out-of-focus amount
566: Illumination direction (φ3)
567: Height of substrate to be inspected at focal depth limit
568: Height of substrate to be inspected when focal depth limit is exceeded
569: Aperture of overhead detection system
570: Distribution of scattered light from defect
571: Illumination at other angle of elevation
572: Lens with different NAs in two directions
573: Low elevation angle detection optic system
600: Bevel portion of substrate to be inspected

1. A defect inspection method for inspecting a substrate to be inspected with light by illuminating the substrate to be inspected, imaging light obtained from the illuminated area, and converting the formed image into a signal strength;
wherein the light is transmitted through an optical element between the substrate to be inspected and the image.

2. The defect inspection method according to claim 1, wherein said optical element is a reflecting mirror.

3. A defect inspection method for detecting a defect in a substrate to be inspected with light, by using a defect inspection device comprising:
an illumination system to illuminate a surface of the substrate to be inspected with a slit-like beam spot;
a detection lens to pick up light obtained from the illuminated area and image it on an image sensor;
one or more image sensors to convert the image into a signal strength; and
a reflection mirror disposed between said detection lens and the substrate to be inspected;
the defect inspection method comprising the steps of:
reflecting light from the illuminated area by said reflection mirror onto said detection lens; and
imaging the light on said image sensor, thereby performing an oblique inspection.

4. The defect inspection method according to claim 3, wherein the angle and direction of the illumination and the position and the angle of said reflection mirror are so set that the zero-th reflected light will not be reflected by said reflection mirror onto said detection lens.

5. The defect inspection method according to claim 2, wherein there are provided a plurality of optical paths in one detection optic system to simultaneously perform a plurality of inspections at different angles of elevation;
wherein in one of the optical paths light from the detection area on the substrate to be inspected is imaged onto the image sensor by the detection optic system and in another optical path light from the detection area on the substrate to be inspected enters the detection optic system through a reflection mirror and is imaged onto the image sensor.

6. A defect inspection device comprising:
a stage mounting a substrate to be inspected and movable relative to an optic system;
an illumination system to illuminate an inspection area on the substrate to be inspected;
a detection optic system to detect light from the inspection area on the substrate to be inspected;
an image sensor to convert the image formed by said detection optic system into a signal;
a signal processing system to process the signal of said image sensor to detect a defect; and
an optical element disposed between said detection optic system and the substrate to be inspected to transmit light from the substrate to be inspected to said detection optic system.

7. The defect inspection device according to claim 6, wherein said optical element is a reflection mirror.

8. The defect inspection device according to claim 6, wherein a reflecting surface of said reflection mirror is set parallel to the pixel direction of said image sensor and inclined with respect to an optical axis of said detection lens.

9. The defect inspection device according to claim 6, wherein said reflection mirror is able to be inserted into or retracted from the optical path by a switching mechanism;
wherein a detection optic system for oblique inspection with said reflection mirror inserted into the optical path and a detection optic system for overhead inspection with said reflection mirror not inserted into the optical path are formed so that a selection can be made between the oblique inspection and the overhead inspection.

10. The defect inspection device according to claim 9, having a plurality of said reflection mirrors with their reflecting surfaces at different angles.

11. The defect inspection device according to claim 6, wherein an optical path length correction element is disposed between said reflection mirror and said detection lens;
wherein the optical path length from the inspection area on the substrate to be inspected to said detection lens is extended by said optical path length correction element to allow the oblique inspection to be performed with said stage set at the same height or close to that used for the overhead inspection.

12. The defect inspection device according to claim 6, wherein an optical path length correction element having an image aberration correction function is disposed between said reflection mirror and said detection lens.

13. The defect inspection device according to claim 6, further comprising:
an optical path branching reflection mirror to branch the light from said reflection mirror exiting from said detection optic system; and
an image sensor for oblique inspection to convert the light branched by said optical path branching reflection mirror into a signal.

14. The defect inspection device according to claim 13, wherein said optical path branching reflection mirror is disposed outside the overhead inspection optical path.

15. The defect inspection device according to claim 13, wherein the detection area is shifted with respect to the optical axis of said detection optic system in a direction perpendicular to a pixel direction of said image sensor.

16. The defect inspection device according to claim 15, wherein the direction, angle of elevation, polarization, and wavelength of the illumination are selectable as an illumination condition.

17. The defect inspection device according to claim 16, wherein, when the polarization is selected as the illumination condition, a beam splitter is disposed between said detection optic system and said image sensor, the light that has passed through said detection optic system is separated into different polarization components by said beam splitter, and said components are imaged onto respective different image sensors.

18. The defect inspection device according to claim 15, wherein two reflection mirrors are disposed facing each other so that their detection areas are shifted in a direction perpendicular to the pixel direction of said image sensor.

19. The defect inspection device according to claim 18, wherein lights from said two reflection mirrors are imaged onto different oblique inspection image sensors respectively and at the same time light directly entering said detection optic system from the substrate to be inspected is imaged onto the overhead inspection image sensor.

20. The defect inspection device according to claim 6, wherein an angle formed between a plane having therein an optical axis of an illumination flux and a longitudinal axis of the beam spot and an optical axis of the light from the beam spot and entering into said optical element is set at about 90 degrees.

21. The defect inspection device according to claim 20, wherein a direction of illumination is set based on a distribution of amount of scattered light captured by said detection optic system and a distribution of amount of pattern-scattered light captured by said detection optic system.

22. The defect inspection device according to claim 6, wherein a numerical aperture in an azimuth direction with reference to the optical axis of said detection optic system is set equivalent to a numerical aperture of said detection optic system.

23. The defect inspection device according to claim 6, wherein a plurality of inspections using inspection optical paths are performed in one operation to obtain a plurality of different inspection results simultaneously, one of the inspection optical paths being adapted to image light from the detection area on the substrate to be inspected onto the image sensor by the detection optic system inclined with respect to the substrate to be inspected, another inspection optical path being adapted to reflect light from the detection area on the substrate to be inspected by a reflection mirror to enter into the detection optic system inclined with respect to the substrate to be inspected so that the light is imaged onto the image sensor.

24. The defect inspection device according to claim 23, wherein the illumination conditions of wavelength, polarizing direction, angle of elevation, and direction are individually set.

25. The defect inspection device according to claim 6, wherein a bevel portion of the substrate to be inspected is inspected.
